(19) United States
(12) Patent Application Publication
(10) Pub. No.: US 2009/0063214 A1
(43) Pub. Date: Mar. 5, 2009

(54) Advertisement Profiling and Selection

(76) Inventor: Xiaomei Liu, San Jose, CA (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(21) Appl. No.: 11/847,764

(22) Filed: Aug. 30, 2007

(51) Int. Cl. G06Q 30/00; G06F 17/40; G06Q 10/00

(52) U.S. Cl. 705/7; 705/14

(57) ABSTRACT

In one embodiment, advertisement consumption data is determined for a viewer. An advertisement is selected from a server based on the determined advertisement consumption data, and the advertisement identification is inserted into a transport stream. A hierarchical categorization of advertisements is used to provide granularity to the advertisement consumption data.

### CROSS REFERENCE TO RELATED APPLICATIONS

Not applicable.

### TECHNICAL FIELD

The present disclosure relates generally to advertising profiling and delivery of targeted advertising.

### BACKGROUND

Advertising is used by many businesses to generate brand recognition and interest in a product or service. Targeted advertising has been used to increase the effectiveness of the brand recognition and the interest in the product or service. However, sometimes the targeted advertising is ineffective and wastes the additional effort commensurate with the process.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a broadband communications system, such as a cable television system, in which an example embodiment may be employed.

FIG. 2 is a block diagram of a headend in the broadband communication system of FIG. 1 in which an example embodiment may be employed.

FIG. 3 is a block diagram of an example embodiment of a hierarchical advertisement identification.

FIG. 4 is a system block diagram of an example embodiment of advertisement profiling and selection.

FIG. 5 is a flow diagram of an example embodiment of a determination of advertisement consumption data, which may be used in advertisement selection.

FIG. 6 is a flow diagram of an example embodiment of advertisement selection.

FIG. 7 is a flow diagram of an example embodiment of advertisement profiling.

### DESCRIPTION OF EXAMPLE EMBODIMENTS

### Overview

Briefly described, in architecture, one example embodiment of a system described in this disclosure, among others, can be implemented with a server configured to receive data associated with a television viewer action directed at an advertisement, the advertisement comprising advertisement identification and category information; determine advertisement consumption data using the received data; and transmit the advertisement consumption data. An example embodiment of a method described in this disclosure, among others, can be broadly summarized by receiving data associated with a television viewer action directed at an advertisement, the advertisement comprising advertisement identification and category information; determining advertisement consumption data using the received data; and transmitting the advertisement consumption data. Another example embodiment of a method described in this disclosure can be broadly summarized by receiving an advertisement; determining category information for the advertisement; and adding the category information to the advertisement.

### Example Embodiments

The logic of example embodiment(s) of the disclosure can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of embodiments of the present disclosure in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of example embodiments of the present disclosure in logic embodied in hardware or software-configured mediums.

Any process descriptions or blocks in flow charts should be understood as representing modules, segments, or portions of code which include one or more executable instructions for implementing specific logical functions or steps in the process, and alternate implementations are included within the scope of embodiments of the present disclosure in which functions may be executed out of order from that shown or discussed, including substantially concurrently or in reverse order, depending on the functionality involved, as would be understood by those reasonably skilled in the art of the present disclosure. In addition, the process descriptions or blocks in flow charts should be understood as representing decisions made by a hardware structure such as a state machine known to those skilled in the art.

The present disclosure will be described more fully hereinafter with reference to the accompanying drawings in which like numerals represent like elements throughout the several figures, and in which an example embodiment is shown. Embodiments of the claims may, however, be embodied in many different forms and should not be construed as limited to the embodiments set forth herein. The examples set forth herein are non-limiting examples and are merely examples among other possible examples.

Traditional advertising in video delivery may be based on a mass market model.

Advertisements are sent to consumers with no differentiation of geographic, demographic, and psychographic segmentations. With the success of Google and targeted advertising, a multi-system operator (MSO), such as a cable company, may be inclined to develop a targeted advertising model. Ad zones, which allow MSOs to target consumers based on geographic segmentation, is the first step that MSOs have taken towards achieving targeted advertising.

Taking this targeted advertising a step further to address the interest of individual viewers faces technical challenges. One such challenge is finding a mechanism to generate an ad consumption profile for each user and for each ad. With ad profiling data, advertisement decision system can select ads that best fit a viewer's interest and advertisers can be charged based on real ad consumption.

One type of ad profiling system today is based on a normal play time (NPT) timestamp. The tuner usage at a specific time is recorded. For example, the measurement is done every second. This tuner information combined with electronic program guides and schedules is used to derive the ad consumption data. The NPT based method has several shortcomings. First, there is a huge amount of data collected as the tuner position is recorded every second or every few seconds. Secondly, when the advertisement is becoming more targeted in the future, the schedule of ads is to be stored for each individual viewer, which is inefficient and unscalable.

Another type of profiling system popular today depends on heavy processing on digital subscriber communication terminals. For example, addressable advertisement systems deliver different copies of advertisements at each advertisement's available time. The digital subscriber communication terminal may be used to select and splice in the right ad. Similarly, in an interactive advertisement, digital subscriber communication terminals interpret embedded information in video streams and render graphics on the screen and wait for user activity. Besides the heavy processing required on the digital subscriber communication terminal side, the interactive advertisement is also intrusive to the viewing experience.

The operator of a subscriber network system may desire the ability to send targeted advertising to subscriber devices over a local area network, which may include wired communication links, wireless communication links, or a combination thereof. The operator may desire to monitor advertisements that a subscriber views using a hierarchical category ID system, among other systems, and select a targeted advertisement based on the results of the monitoring. For example, a cable operator, through the monitoring, may determine that a subscriber watches a larger percentage of food-related commercials than personal hygiene commercials. It can be determined from the monitoring that this subscriber's particular interests lean more to food-related products and services than to personal hygiene related products and services. Then, based on the determination, the cable operator may send more food-related commercials to match the interest of the particular subscriber.

A description of a subscriber television system is provided hereinbelow. First an overview of a subscriber television system is given, then a description of the functionality and components of the headend is provided, and then a description of the functionality and components of a digital subscriber communication terminal (DSCT) and a client-receiver at a subscriber location is given. Non-limiting embodiments of the present disclosure are described in the context of a DSCT located at the subscriber's location.

### Subscriber Television System Overview

In this disclosure, a two-way interactive digital subscriber television system or a digital subscriber network may also be referred to as a Digital Broadband Delivery System (DBDS). An overview of an example DBDS is provided in U.S. Pat. No. 6,157,719, entitled “Conditional Access System”, which is hereby incorporated by reference herein in its entirety. Functions of the DBDS may include: providing interfaces to content providers, service providers, advertisement providers, and entitlement agents; controlling access to and the use of the content, services, and advertisements; and distributing the content, services, and advertisements to subscribers. For the purposes of this disclosure, an entitlement agent may be an entity that provides the subscribers of the DBDS with entitlements for services and content associated with the entitlement agent. The content providers, services providers, and advertisement providers may not want to be in the business of managing entitlements for the subscribers of the DBDS. In that case, the content, services, and advertisements from the content, service, and advertisement providers are associated with the entitlement agent and the entitlement agent provides the subscribers with the entitlements for the associated content, services, and advertisements. In addition, services, content, and advertisements associated with an entitlement agent include services, content, and advertisements provided to the DBDS by the entitlement agent.

The subscriber network system offers subscribers of the system services such as, but not limited to, Internet service, telephone service, program selections, advertisement selections, or service instances. Advertisement selections, include, but are not limited to, an installment of an audio or visual or audio/visual selections from an advertiser. An advertisement selection can be broadcast to all of the subscribers of the subscriber network system, a portion of the subscribers, or an individual subscriber. Advertisement selections may be included in regular programming, special programming such as pay-per-view, and subscriber requested services such as personal television.

The subscriber network system may include a variety of media, which may handle multiple in-band signals. Typically, in a subscriber system, such as a cable television system, the in-band signals are 6 MHz wide, which correspond to the bandwidth used to transmit a conventional analog television program. Today, many programs, service instances, and advertisements are transmitted in a digital format, such as, but not limited to, the motion picture experts group (MPEG) format.

### MPEG Programming

In a digital format, a program, service, or advertisement may be encoded into its elementary parts, such as video, audio, etc. Frequently, a program can include more than one audio track so that the program can be heard in several different languages such as English, French, or German, and each audio track is an elementary stream of the program. The program is further encoded so that the elementary parts are packetized into multiple packets. MPEG is a common format used for packetizing a digital program. A packet identifier (PID) identifies each of the packets, and all of the packets that make up an elementary part of the program have the same PID values. For example, all of the video packets might have the PID value of 251 and, all of the English audio packets might have a PID value of 255, etc.

In a conventional analog system, only one analog program is transmitted through a 6 MHz wide frequency band, but a 6 MHz wide frequency band can carry a transport stream that includes several multiplexed digital programs. The packets of a digital program are transmitted in a transport stream, which is a continuous stream of packets. Generally, the transport stream is made up of multiple programs or service instances that are multiplexed together. The transport stream is made up of elementary streams or PID streams, which are streams of packets having the same PID values. Each PID stream of the transport stream has a unique value. The packets of a program are transmitted in a synchronized manner, such that the packets of the program are received at the appropriate time so that the video and audio are synchronized when the program is viewed. For the purposes of this disclosure, a digital transport stream is described in terms of an MPEG transport stream, but this is for example purposes only.

In an MPEG transport stream, the PID values may range from 0 to 8,191. Certain PID values such as zero and 8,191 are reserved and are assigned to packets having specific information or functions. For example, stuffing packets, which are assigned the PID value of 8,191, are filler packets that are inserted into the transport stream when there are no other packets available for transmission. Program association tables are assigned the PID value of zero, and are used to map advertisements to their program map tables. (Each advertisement of a transport stream has a unique program identification.) For example, an advertisement such as a “Pizza Hut” commercial can have the program number of 15, and in that case, the program association table maps program number 15 to a program map table, such as program map table 256. The program map table 256 is carried in one or more packets of the transport stream that have the PID value 256, and program map table 256 maps the elementary streams of program 15 to their PID streams. For example, program map table 256 maps the video stream of the “Pizza Hut” commercial to PID stream 262, and English audio stream to PID stream 263.

MPEG as referenced in this disclosure is described in the MPEG-1, MPEG-2 and MPEG-4 standards. The MPEG-1 standards (ISO/IEC 11172), the MPEG-2 standards (ISO/IEC 13818) and the MPEG-4 standards (ISO/IEC 14496) are described in detail in the International Organization for Standardization document ISO/IEC JTC1/SC29/WG11 N (June 1996 for MPEG-1, July 1996 for MPEG-2, and October 1998 for MPEG-4), which is hereby incorporated by reference.

### Subscriber Television Network

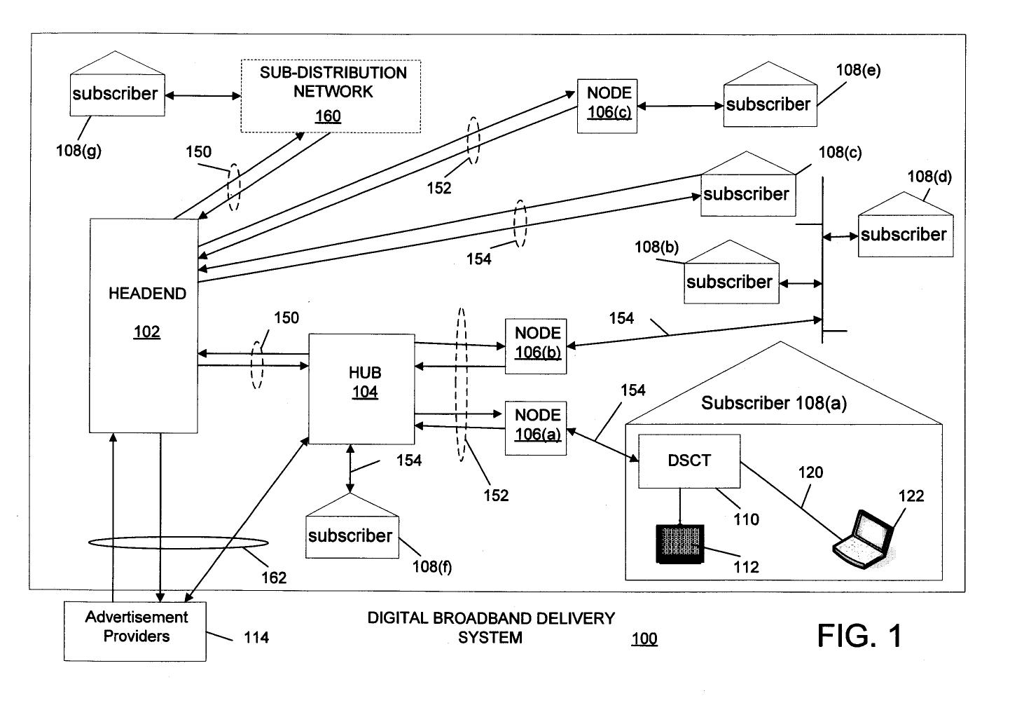

Referring to FIG. 1, a digital broadband distribution system (DBDS) 100 includes, in one example among others, a headend 102, a plurality of hubs 104, multiple nodes 106, a plurality of subscriber locations 108, and a plurality of digital subscriber communication terminals (DSCTs) 110. The headend 102 provides the interface between the DBDS 100 and advertisement providers 114, or entitlement agents, such as broadcasters, Internet service providers, and the like via communication link 162. The communications link 162 between the headend 102 and the content and service providers 114 may be two-way. This allows for two-way interactive services such as Internet access via DBDS 100, video-on-demand, interactive program guides, monitoring of subscriber viewing patterns, etc. In an example embodiment, the hubs 104 are also in direct two-way communication with the content, service, and advertisement providers 114 via communication link 162 for providing two-way interactive services.

In an example embodiment, the headend 102 is in direct communication with the hubs 104 via communication link 150. In addition, the headend 102 is in direct communication with the nodes 106 via communication link 152 and in direct communication with the subscriber locations 108 via communication link 154. Whether or not the headend 102 is in direct communication with subscriber locations 108 is a matter of implementation. In an alternative embodiment, the headend 102 is in direct communication with hubs 104 and nodes 106 and in direct communication with subscriber locations 108.

In an example embodiment of systems and methods of advertisement profiling, the hub 104 receives advertisements and other information, which is typically in a protocol such as ATM or Ethernet, from headend 102 via transmission medium 150. The hub 104 transmits information and advertisements via transmission medium 152 to nodes 106, which then transmit the information and advertisements to subscriber locations 108 through transmission medium 154. Whether the hub 104 communicates directly to subscriber locations 108 or to nodes 106 is a matter of implementation, and in an example embodiment, the hub 104 is also adapted to transmit information and advertisements directly to subscriber locations 108 via transmission medium 154.

In an example embodiment, the transmission medium 150 and 152 are optical fibers that allow the distribution of high-quality and high-speed signals, and the transmission medium 154 is either broadband coaxial cable or optical fiber. When the communication path from the headend 102 to the DSCT 110 includes a combination of coaxial cable and optical cable, the communication path is frequently referred to as a hybrid fiber coax (HFC) communication path. In alternative embodiments, the transmission media 150, 152 and 154 can include one or more of a variety of media, such as optical fiber, coaxial cable, satellite, direct broadcast, terrestrial digital, Multichannel Multipoint Distribution System (MMDS) or other transmission media known to those skilled in the art. Typically, the transmission media 150, 152 and 154 are two-way communication media through which both in-band and out-of-band information are transmitted. Through the transmission media 150, 152, and 154 subscriber locations 108 are in direct or indirect two-way communication with the headend 102 and/or the hub 104. Typically, when the DSCT 110 is in satellite communication with the headend 102, the communication path is one-way from the headend 102 to the DSCT 110. However, in an alternative embodiment, the DSCT 110 and the headend 102 are in two-way communication via a telephone network (not shown).

The hub 104 functions as a mini-headend for the introduction of programming, advertisements, and services to sub-distribution network 160. The sub-distribution network 160 includes hub 104 and the plurality of nodes 106 connected to hub 104. Having a plurality of hubs 104 that function as mini-headends facilitates the introduction of different programming, advertisements and services to different sub-distribution networks of DBDS 100. For example, the subscriber location 108(b), which is connected to node 106(b), can have different services, advertisements, and programming available than the services, advertisements, and programming available to subscriber location 108(c), which is connected directly to headend 102, even though the subscriber locations 108(b) and 108(c) may be in close physical proximity to each other. Services, advertisements, and programming for subscriber location 108(b) are routed through hub 104 and node 106(b); and hub 104 can introduce services, data and programming into the DBDS 100 that are not available through the headend 102.

At the subscriber locations 108 a decoder or a DSCT 110 provides the two-way interface between the DBDS 100 and the subscriber. The DSCT 110 decodes and further process the signals for display on a display device, such as a television (TV) set 112 or a computer monitor, among other examples. Those skilled in the art will appreciate that in alternative embodiments the equipment for first decoding and further processing the signal can be located in a variety of equipment, including, but not limited to, a DSCT, a computer, a TV, a monitor, or an MPEG decoder, among others.

The DSCT 110 is preferably in communication with client-receiver 122 via communication link 120. In an example embodiment, the communication link 120 is wireless such as, but not limited to, Institute for Electronics and Electrical Engineers (IEEE) standards 802.11a, 802.11b, 802.11g, HiperLAN/2, HomeRF 2, Bluetooth 2, and 802.15.3. In alternative embodiments, the DSCT 110 is in communication with multiple client-receivers via one or more communication links, such as, but not limited to, twisted-pair or Ethernet, telephone line, electrical power line and coaxial cable.

The client-receiver 122 is in two-way communication with the DSCT 110 and may receive information and advertisements therefrom. In one embodiment, the DSCT 110 acts as a proxy for the client-receiver 122, and in that case, the headend 102 transmits advertisements and messages to the DSCT 110, which then processes the advertisements before re-transmitting them to the client-receiver 122. In this embodiment, the headend 102 may or may not be aware of the client-receiver 122. Because the DSCT 110 proxies for the client-receiver 122, the headend 102 need only communicate with the DSCT 110. In another embodiment, the client-receiver 122 is acknowledged by the headend 102, and the headend 102 communicates with the client-receiver 122 through the DSCT 110. The DSCT 110 still processes messages communicated between the headend 102 and the client-receiver 122, but in this embodiment, the DSCT 110 acts as a facilitator, not as a proxy, for the client-receiver 122. For example, in one embodiment, the DSCT 110 authenticates and when necessary decrypts messages from the headend 102 that are addressed to the client-receiver 122. In another embodiment, the DSCT 110 is a gateway for the client-receiver 122 and merely passes communication between the client-receiver 122 and the headend 102. In yet another embodiment, the DSCT 110 decrypts messages and other information from the headend 102 and re-encrypts them for the client-receiver 122.

### Headend

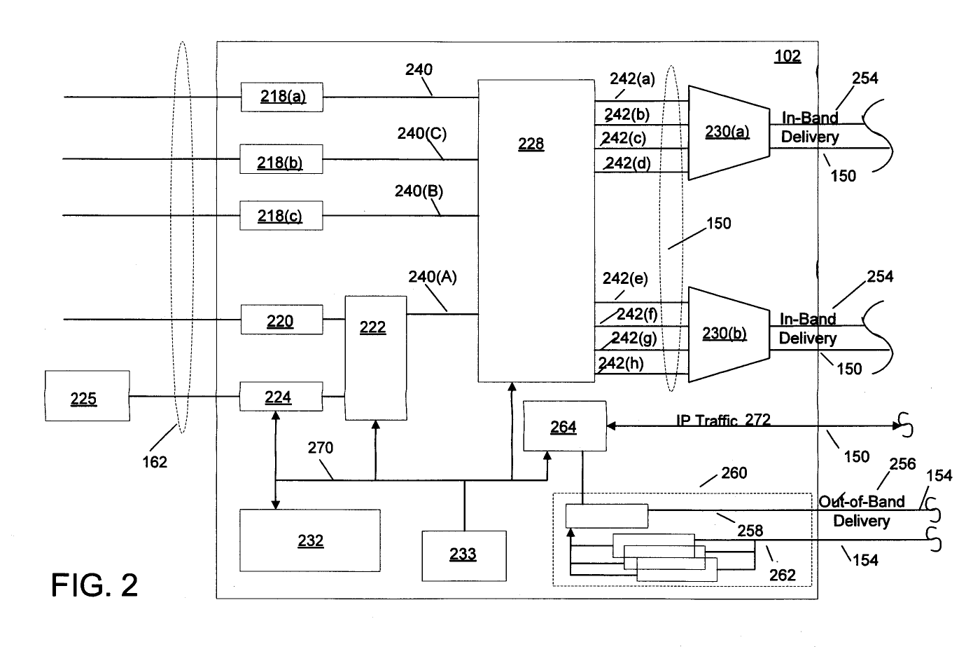

Referring to FIG. 2, in a typical system of an example embodiment, the headend 102 may receive advertisements from a variety of input sources, which can include, but are not limited to, a direct feed source (not shown), a video camera (not shown), an application server (not shown), and other input sources (not shown). The input signals are transmitted from the advertisement providers 114 (shown in FIG. 1) to the headend 102 via a variety of communication links 162, which include, but are not limited to, satellites (not shown), terrestrial broadcast transmitters (not shown) and antennas (not shown), and direct lines (not shown). The signals provided by the advertisement providers can include a single advertisement or a multiplex of advertisements.

The headend 102 generally includes a plurality of receivers 218 that are each associated with a source. A program may be transmitted from the receivers 218 in the form of transport stream 240. MPEG encoders, such as encoder 220, are included for digitally encoding the program. Typically, the encoder 220 produces a variable bit rate transport stream. Prior to being modulated, some of the signals may require additional processing, such as signal multiplexing, which is performed by multiplexer 222.

A switch, such as asynchronous transfer mode (ATM) switch 224, may provide an interface to an advertisement server 225. There may be multiple advertisement servers providing a variety of advertisements. Service, content, and advertisement providers 114 (shown in FIG. 1) may download advertisements to an advertisement server located within the DBDS 100 or in communication with DBDS 100. The advertisement server may be located within headend 102 or elsewhere within DBDS 100, such as in a hub 104 or DSCT 110 (shown in FIG. 1).

The advertisements input into the headend 102 are then combined with the other information, which is specific to the DBDS 100, such as local programming and control information. The headend 102 may include a multi-transport stream receiver-transmitter 228, which receives the plurality of transport streams 240 and transmits a plurality of transport streams 242. In an example embodiment, the multi-transport stream receiver-transmitter 228 includes a plurality of modulators, such as, but not limited to, Quadrature Amplitude Modulation (QAM) modulators, that convert the received transport streams 240 into modulated output signals suitable for transmission over transmission medium 150.

In an example embodiment, the output transport streams 242 have a bandwidth of 6 MHz centered upon a frequency that is predetermined for each transport stream 242. The frequency for a given transport stream 242 is chosen such that the given transport stream is not combined with another transport stream at the same frequency. In other words, transport streams that are modulated at different frequencies can be combined, and therefore, the frequencies of transport streams 242A-D are different from each other because combiner 230A combines them. The transport streams 242 from the multi-transport stream receiver-transmitters 228 are combined, using equipment such as combiner 230, for input into the transmission medium 150, and the combined signals are sent via the in-band delivery path 254 to subscriber locations 108.

A system controller, such as control system 232, which preferably includes computer hardware and software providing the functions discussed herein, allows the DBDS system operator to control and monitor the functions and performance of the DBDS 100. The control system 232 interfaces with various components, via communication link 270, in order to monitor and/or control a variety of functions, including advertisement determination and splicing, the channel lineup of the programming for the DBDS 100, billing for each subscriber, and conditional access for the content distributed to subscribers. Control system 232 provides input to the multi-transport stream receiver-transmitter 228 for setting its operating parameters, such as system specific MPEG table packet organization or conditional access information, among other things.

Advertisements may be communicated to DSCTs 110 via the in-band delivery path 254 or to DSCTs 110 (see FIG. 1) connected to the headend 102 via an out-of-band delivery path 256. The out-of-band data is transmitted via the out-of-band downstream path 258 of transmission medium 154 by means such as, but not limited to, a Quadrature Phase-Shift Keying (QPSK) modem array 260, or an array of data-over-cable service interface specification (DOCSIS) modems, or other means known to those skilled in the art. Two-way communication utilizes the upstream portion 262 of the out-of-band delivery system. DSCTs 110 may transmit out-of-band data such as and advertisement monitoring information through the transmission medium 154, and the out-of-band data may be received in headend 102 via out-of-band upstream paths 262. The out-of-band data may be routed through router 264 to data collection server 233. Out-of-band control information may include subscriber advertisement viewing data. Other out-of-band control information may include, as non-limiting examples, a pay-per-view purchase instruction and a pause viewing command from the subscriber location 108 (shown in FIG. 1) to a video-on-demand type application server, and other commands for establishing and controlling sessions, such as a Personal Television session, etc. The QPSK modem array 260 may also be coupled to communication link 152 (FIG. 1) for two-way communication with the DSCTs 110 coupled to nodes 106 (see FIG. 1).

The router 264 may be used for communicating with the hub 104 through transmission medium 150. Advertisement data collection data, command and control information among other information between the headend 102 and the hub 104 may be communicated through transmission medium 150 using a protocol such as, but not limited, to Internet Protocol (IP). The IP traffic 272 between the headend 102 and hub 104 may include information to and from DSCTs 110, which are connected to the hub 104.

In an example embodiment, the hub 104, which functions as a mini-headend, may include many or all of the same components as the headend 102. The hub 104 may be adapted to receive the transport-streams 242 included in the in-band path 254 and redistribute the content therein throughout its sub-distribution network 160. The hub 104 may include a QPSK modem array (not shown) that is coupled to communication links 152 and 154 for two-way communication with DSCTs 110 that are coupled to its sub-distribution network 160. Thus, it may also be adapted to communicate with the DSCTs 110 that are coupled to its sub-distribution network 160, with the headend 102, and with the advertisement providers 114.

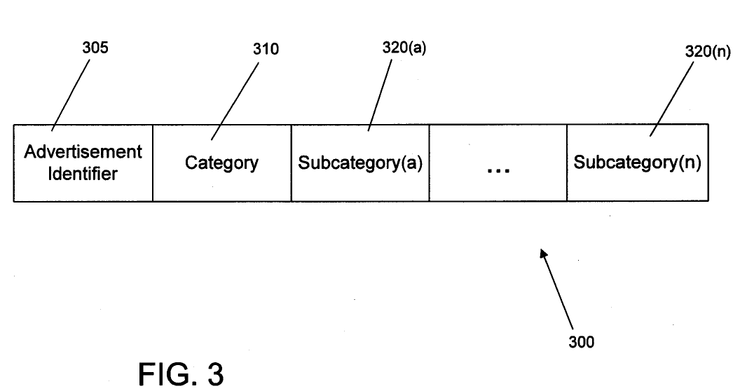

To facilitate the collection of advertisement viewing data, each ad may be allocated a unique ID in a multi-system operator's (MSO's) video delivery system. Part of the ID may be the identifier for an advertiser or a provider of an advertisement. Another part may uniquely identify the ad from a given advertiser or advertisement provider. Each advertisement may be categorized using a hierarchical category ID system 300, an example of which is provided in FIG. 3. In hierarchical ad category ID 300, field 305 may contain an advertiser ID and an advertisement ID. The advertiser ID uniquely identifies all advertisers; whereas, the advertisement ID uniquely identifies advertisements within a particular advertiser. Field 310 may contain an ID for a category and fields 320(a) . . . 320(n) may contain IDs of sub-categories. For example, a Pizza Hut ad can be categorized as: Food/Restaurant/Italian/Pizza/Pizza Hut. As an example, the hierarchical ad category ID 310 and subcategory ID 320 can be 8 bytes long and each byte may represent a subcategory. The most significant byte may be the root category and the least significant byte may be the leaf category. The category ID may be maskable so that ad profile summaries may be performed at different levels.

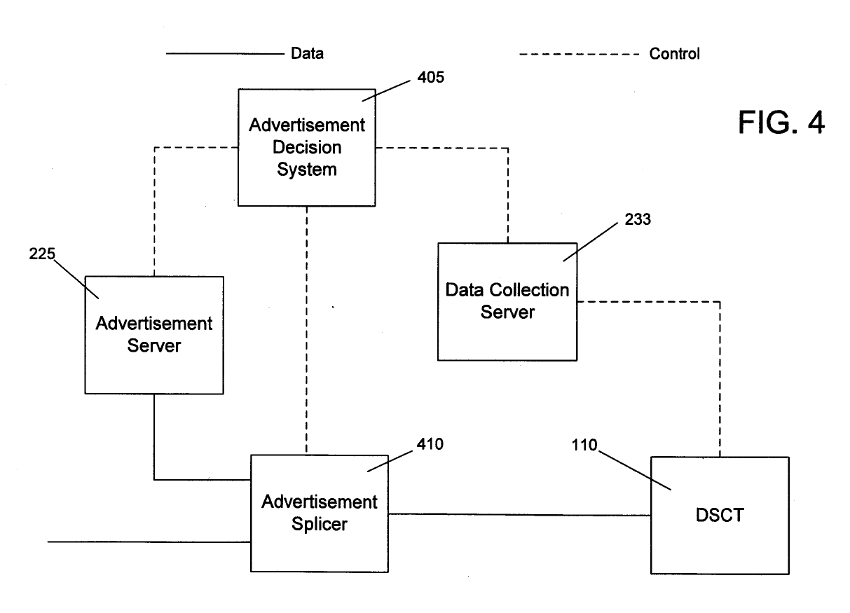

To determine whether a particular advertisement is appropriate for a particular viewer, data regarding the consumption of advertisements by a viewer may be collected using the system provided in FIG. 4. The system for providing targeting advertisements using advertisement profiling includes DSCT 110, advertisement server 225, data collection server 233, advertisement decision system 405 and advertisement splicer 410. An ad consumption score can be given to an ad based on viewer action. When a viewer watches an advertisement, the parameters of the viewer's watching behavior may be collected in DSCT 110 and sent to data collection server 233. A scoring table may be used to determine whether the advertisement is suitable for the viewer. A non-limiting example list of scores from the lowest to the highest follows. In this example, the higher the score, the more suitable the ad is for this particular viewer.
Skipped during viewing (user skips the rest of ad after viewing the beginning of the ad). The behavior of skipping during viewing indicates the user's dislike of the advertisement content. Therefore, this ad may be assigned the lowest score among all the score categories listed here. In an alternative embodiment, a relative score within this score category may be assigned depending on how long this ad has been watched before being skipped.
Blindly skipped (viewer skips an ad without viewing the ad content). This behavior may not indicate the user's dislike of a particular ad. Therefore, the score for this category may be higher than the skipped during viewing category.
Fully watched (viewer finishes watching the ads). This behavior indicates the user's affinity for this particular ad. Therefore the score may be higher than the previous category.
Watched repetitively using trick mode (rewind, play, etc). This behavior indicates the user really like this ad. Therefore, the score should be the highest among all the score categories. In an alternative embodiment, a relative score within this category may be assigned depending on how many times an ad is watched.

The scoring of the example system is event driven rather than time drive as in an NPT system.

Advertisement ID 300 may be sent inband with the video stream. This information may be added at a different level of the stream. In one example embodiment, it can be added at MPEG2 transport stream (TS) level using a private data packet. The private data program identifier (PID) may appear in a program map table. In one example embodiment:

```
Transport Packet
    0x47
    Private PID ----- This is indicated in PMT
    Private_section ( ) {
        Header
        Private data bytes
    }
Transport Packet
```

The advertisement ID 300 may be inserted into the transport stream by advertisement splicer 410.

Alternatively, private advertisement ID 300 may be inserted at MPEG elementary stream level (e.g. GOP or picture level). This private data packet may be aligned at the boundary of each ad. The service provider can define the exact format of advertisement ID 300. As an example, when MPEG TS level private data is used, the advertisement ID 300 can use the MPEG-TS private table format so that this information can be combined with other private data in the same private data packet.

In an example embodiment, a device such as a decoder in DSCT 110 may keep an advertisement table. This advertisement table may have granularity down to individual ads. During video decoding, the decoder of DSCT 110 may search for an advertisement ID 300. The DSCT 110 can use this information to determine advertisement ID and category as well as to associate the advertisement with an advertisement consumption score.

Data collection server 233, which may be located in either DSCT 110 or at headend 102, may then take collected advertisement consumption data from DSCT 110. To control the data-reporting load, the data collection server 233 can control the reporting interval and category summary granularity. For example, the advertisement viewing score can be summarized by hierarchical category and reported to data collection server 233. This provides a scalable solution so that data collection server 233 is not overloaded with a large amount of data. Data collection server 233 can then be connected with ad decision system 405 to decide the which advertisements would be most appropriate for the viewer based on the advertisement consumption score of the viewer.

In an example embodiment, the method of providing targeted advertising may not use any private identifiable information. Viewers may be given the option to prevent the reporting to the data collection server 233 of the advertisement consumption score collected by DSCT 110. The viewer may be left with a default profile for advertisement selection purposes.

For unicast content such as content provided by video on demand (VOD) and network personal video recorder (nPVR) applications, the ad profile table may be used directly to choose advertising content for a viewer. Unicast content refers to a system in which each user receives her own version of content. This is in contrast to broadcast content in which all users share the same version of content. For example, for unicast content, even though viewerA and viewerB are watching CNN at the same time, the CNN content may be different for each viewer since viewerA may start watching before viewerB, and also because viewerA may use pause/rewind during the CNN viewing.

For broadcast and switched broadcast content, a switched broadcast manager may collect channel change requests from each individual viewer. The switched broadcast manager determines how many viewers are watching a broadcast or switched broadcast channel at a certain time. The switched broadcast manager also determines the identities of these viewers. A channel ad profile may be generated as a summary ad profile of all viewers who are watching the channel. The channel ad profile may be used to select the advertisements for the broadcast/switched broadcast channel. The channel ad profile may be updated dynamically as viewers tune into and out of each channel. The dynamic channel ads profile update may not affect the channel change time, the period between the time a user selects a channel to watch and the time the content appears. For example, the ad profile update may be performed as a background process.

Methods and systems disclosed herein may be non-intrusive and privacy protected. The methods may use in-band metadata to uniquely identify ads. Because the in-band data is synchronized with the advertisement content, user activities and ad consumption behavior can be accurately associated and recorded. Ad consumption effectiveness may be measured using the ad consumption score. Methods disclosed herein may incur minimal processing loads on DSCT 110.

Methods and systems disclosed herein may be scalable. The advertisement consumption data collection and advertisement selection may be event driven, rather than a time driven, (NPT)-based advertisement profile system. The amount of data per user may be a magnitude lower to identify ads compared with the NPT based system. Methods and systems disclosed herein may provide a category and summary function to further decrease the load on the data collection server 233. The data collection server 233 may control the amount of data and the level of summary between DSCT 110 and data collection server 233. The category and summary information may also help the advertisement decision system 405 to make advertisement decisions efficiently. Methods and systems disclosed herein may be used in both traditional ad splice systems and DSCT based splice systems. Methods and systems disclosed herein are not limited to cable TV, but may also be used for Telco, IPTV, etc.

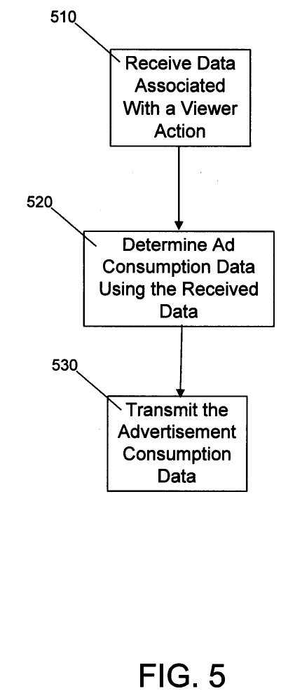

FIG. 5 provides a flow diagram of an example embodiment of a determination of advertisement consumption data, which may be used for advertisement selection. In block 510, data is received. The received data may be associated with a viewer action directed at an advertisement. The advertisement may comprise advertisement identification and category information. In block 520, advertisement consumption data is determined using the received data. In block 530, the advertisement consumption data is transmitted.

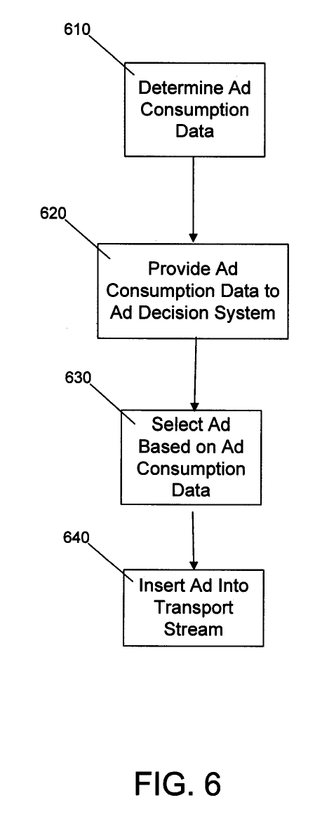

FIG. 6 provides a flow diagram of an example embodiment of advertisement selection. In block 610, advertisement consumption data for a viewer is determined. In block 620, the advertisement consumption data is provided to an advertisement decision system. In block 630, an advertisement is selected by the advertisement decision system based on the advertisement consumption data. In block 640, the selected advertisement is inserted into a transport stream.

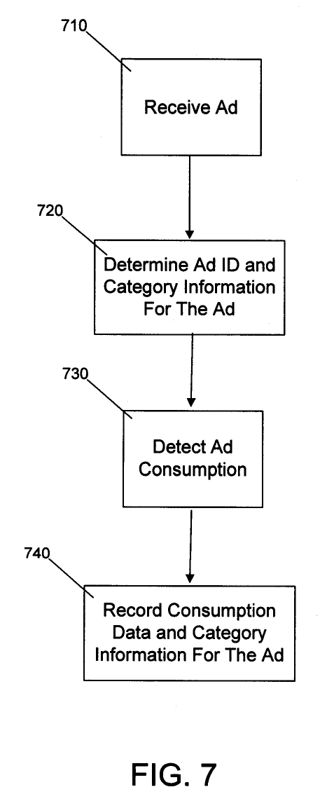

FIG. 7 provides a flow diagram of an example embodiment of advertisement profiling. In block 710, an advertisement is received. In block 720, advertisement ID and category information is determined for the advertisement. In block 730, advertisement consumption is detected. In block 740, the consumption data and the category information is recorded for the advertisement.

It should be emphasized that the above-described embodiments of the present disclosure are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A method comprising:
receiving data associated with a television viewer action directed at an advertisement, the advertisement comprising advertisement identification and category information;
determining advertisement consumption data using the received data; and
transmitting the advertisement consumption data.

2. The method of claim 1, further comprising selecting an advertisement from an advertisement server based on the determined advertisement consumption data.

3. The method of claim 2, further comprising inserting the advertisement into a transport stream.

4. The method of claim 1, wherein the data is received from a digital subscriber communications terminal.

5. The method of claim 1, wherein transmitting the advertisement consumption data comprises transmitting the advertisement consumption data to an advertisement decision server.

6. The method of claim 1, wherein the television viewer action is one of a plurality of actions, the plurality comprising:
skipping the advertisement during viewing;
skipping the advertisement before viewing;
viewing the entire advertisement; and
viewing the advertisement repeatedly.

7. The method of claim 1, wherein the advertisement consumption data for the television viewer is a default value.

8. A method comprising:
receiving an advertisement;
determining category information for the advertisement; and
adding the category information to the advertisement.

9. The method of claim 8, further comprising adding the category information to the advertisement in an advertisement identification.

10. The method of claim 9, wherein the advertisement identification comprises a plurality of fields.

11. The method of claim 9, wherein the advertisement identification and category information are added into a transport stream.

12. The method of claim 9, wherein the advertisement identification and category information are added into a transport stream using a private data packet.

13. The method of claim 12, wherein the private data packet is aligned at the boundary of the advertisement.

14. The method of claim 8, wherein the category information is added at an elementary stream level.

15. A system comprising:
a processor configured to:
receive data associated with a television viewer action directed at an advertisement, the advertisement comprising advertisement identification and category information;
determine advertisement consumption data using the received data; and
transmit the advertisement consumption data; and
memory.

16. The system of claim 15, further comprising an ad decision system configured to select an advertisement based on the advertisement consumption data and to insert the advertisement into a transport stream.

17. The system of claim 15, further comprising a digital subscriber communications terminal configured to produce a profile summary using the advertisement consumption data comprising hierarchical category information.

18. The system of claim 15, further comprising a digital subscriber communications terminal configured to measure advertisement consumption effectiveness using a scoring system applied to the advertisement consumption data.

19. The system of claim 17, further comprising a data collection server configured to receive the data from the digital subscriber communications terminal.

20. The system of claim 15, wherein the action of the television viewer is one of a plurality of actions, the plurality comprising:
skipping the advertisement during viewing;
skipping the advertisement before viewing;
viewing the entire advertisement; and
viewing the advertisement repeatedly.
